(19) United States
(12) Patent Application Publication
(10) Pub. No.: US 2003/0154714 A1
(43) Pub. Date: Aug. 21, 2003

(54) Sensor arrangement for watercraft

(76) Inventor: Kazumasa Ito, Shizuoka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/341,485

(22) Filed: Jan. 13, 2003

(30) Foreign Application Priority Data
Jan. 11, 2002 (JP) 2002-004339

(51) Int. Cl. F02D 41/00; F01N 3/10

(52) U.S. Cl. 60/299; 123/672

(57) ABSTRACT

A watercraft incorporates a multiple cylinder engine and an exhaust system that guides exhaust gases from the engine to an external location. An oxygen sensor is provided to detect a residual amount of exhaust gases. An engine body of the engine defines a plurality of inner exhaust passages that communicate with respective combustion chambers. The exhaust system incorporates an exhaust conduit such as an exhaust manifold that defines individual exhaust passages therein that communicate with the respective inner exhaust passages. The oxygen sensor is positioned either at one of the inner exhaust passages or at one of the individual exhaust passages.

### PRIORITY INFORMATION

This application is based on and claims priority to Japanese Patent Application No. 2002-004339, filed on Jan. 11, 2002, the entire contents of which is hereby expressly incorporated by reference.

### BACKGROUND OF THE INVENTION

1. Field of the Invention

The present invention relates generally to a sensor arrangement for a watercraft, and more particularly to an improved sensor arrangement for a watercraft that incorporates a sensor detecting a condition of exhaust gases.

2. Description of Related Art

Relatively small watercraft such as, for example, personal watercraft, have become very popular in recent years. This type of watercraft is quite sporting in nature and carries one or more riders. A hull of the watercraft typically defines a rider's area above an engine compartment. An internal combustion engine powers a jet pump unit that propels the watercraft by discharging water rearwardly. The engine lies within the engine compartment in front of a tunnel which is formed on an underside of the hull. At least part of the jet pump assembly is placed within the tunnel and includes an impeller that is driven by the engine to propel the watercraft.

Such personal watercraft also include an exhaust system that guides exhaust gases from the engine to an external location. Typically, the exhaust system comprises a series of several exhaust conduits, the final conduit defining an exhaust outlet at a portion of the tunnel or at a portion of the stern under the water. The exhaust system normally has a water preclusion feature that inhibits the water from flowing upstream toward the engine. Despite such water preclusion devices, water and/or water mist can flow upstream under certain conditions.

Many modern personal watercraft include an array of sensors for detecting various conditions of the engine, engine components, and the watercraft. An engine controller can use output signals from the sensors to control engine operation. The sensors can include a sensor that detects a condition of the exhaust gases such as or an oxygen (O₂) sensor, for example. An oxygen sensor typically is configured to detect a residual amount of oxygen in the exhaust gases and to send a corresponding signal to the engine control device. The engine control device thus can recognize whether the engine operates under an appropriate air-fuel ratio condition or not.

For example, U.S. Pat. No. 6,068,530 discloses such an oxygen sensor disposed in a sensor chamber branched from a combustion chamber. Because high pressures and temperatures are generated in the combustion chamber, the sensor chamber and the sensor are designed to withstand at least these high temperatures and pressures.

### SUMMARY OF THE INVENTION

In accordance with one embodiment of one of the inventions disclosed herein, a watercraft comprises an internal combustion engine. An exhaust system is arranged to route exhaust gases from the engine to an external location. A sensor is configured to detect a condition of the exhaust gases. The engine comprises an engine body. A plurality of movable members is movable within the engine body. The engine body and the movable members together define a plurality of combustion chambers. The engine body additionally defines a plurality of inner exhaust passages that communicate with the respective combustion chambers. The exhaust system comprises an exhaust conduit defining individual exhaust passages that communicate with the respective inner exhaust passages. The sensor is positioned either at an upper portion of one of the inner exhaust passages or the individual exhaust passages.

In accordance with another embodiment of one of the inventions disclosed herein, a watercraft comprises a multiple cylinder engine defining a plurality of combustion chambers. An exhaust system is arranged to guide exhaust gases from the combustion chambers to an external location. The exhaust system defines a plurality of parallel exhaust passages that communicate with the respective combustion chambers, and an oxygen sensor positioned at an upper portion of one of the exhaust passages.

In accordance with another embodiment of one of the inventions disclosed herein, an internal combustion engine for a watercraft comprises an engine body, a plurality of movable members movable within the engine body, the engine body and the movable members together defining a plurality of combustion chambers. The engine additionally defines a plurality of inner exhaust passages that include a generally horizontally extending portion and that communicate with the respective combustion chambers. An exhaust system is arranged to guide exhaust gases from the combustion chambers to an external location. The exhaust system comprises an exhaust conduit defining individual exhaust passages that include at least one generally horizontally extending portion and that communicate with the respective inner exhaust passages. A sensor is configured to detect a condition of the exhaust gases and is positioned at an upper portion of a generally horizontally extending portion of either one of the inner exhaust passages or the individual exhaust passages.

### BRIEF DESCRIPTION OF THE DRAWINGS

These and other features, aspects and advantages of the inventions disclosed herein are described below with reference to the drawings of preferred embodiments which are intended to illustrate and not to limit the inventions. The drawings comprise eleven figures.

FIG. 1 is a side elevational view of a personal watercraft configured in accordance with a preferred embodiment of at least one of the inventions disclosed herein, and with certain internal components, such as an engine, fuel tank, and storage bin shown in phantom.

FIG. 2 is a top plan view of the watercraft of FIG. 1.

FIG. 3 is a partial cross-sectioned and rear elevational view of the watercraft shown in FIG. 2.

FIG. 4 is a front, top, and starboard side perspective view of an engine and an exhaust system shown in FIG. 2.

FIG. 5 is a top, front, and port side perspective view of the engine and the exhaust system shown in FIG. 2.

FIG. 6 is a starboard side elevational view of the engine and the exhaust system shown in FIG. 2. The exhaust system is illustrated partially in cross-section.

FIG. 7 is a schematic top plan view of the engine and the exhaust system shown in FIG. 2. A plenum chamber assembly is detached and a downstream portion of the exhaust system is omitted in this figure.

FIG. 8 is a schematic starboard side elevational view of the engine and the exhaust system shown in FIG. 2. The plenum chamber assembly is detached and the downstream portion of the exhaust system is omitted in this figure.

FIG. 9 is a cross-sectional view of one coupling portion of an exhaust manifold of the exhaust system including a sensor mounting arrangement constructed in accordance with an embodiment of at least one invention disclosed herein.

FIG. 10 is a partial cross-sectional view of first and second unitary conduits that define individual exhaust passages therein and a sensor mounting arrangement in accordance with another embodiment of at least one invention disclosed herein.

FIG. 11 is a partial cross-sectional view of an inner exhaust passage and the exhaust manifold that are configured in accordance with yet another embodiment of at least one invention disclosed herein.

### DETAILED DESCRIPTION OF THE PREFERRED EMBODIMENT OF THE INVENTION

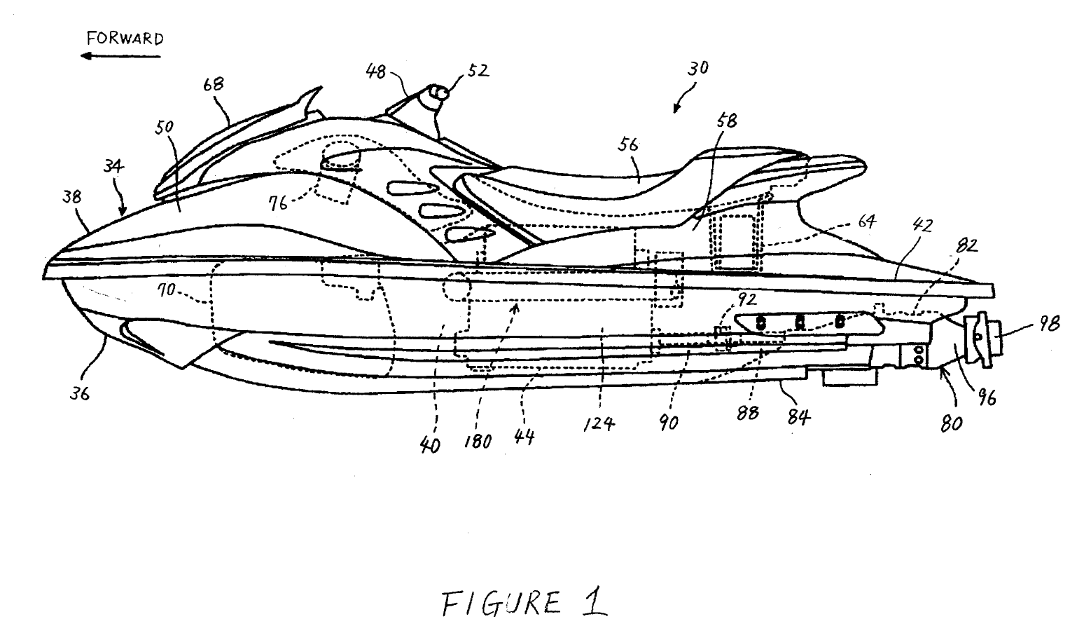

With reference to FIGS. 1-3, an overall construction of a personal watercraft 30 is described below to provide the user with an understanding of at least one environment of use of the inventions disclosed herein. The inventions disclosed herein can be used with other types of watercraft such as jet boats or other motor boats inasmuch as they are powered by an internal combustion engine and has an exhaust system that routes exhaust gases to an external location. Applicable watercraft will become apparent to those of ordinary skill in the art.

The personal watercraft 30 includes a hull 34 generally formed with a lower hull section 36 and an upper hull section or deck 38. Both the hull sections 36, 38 are made of, for example, a molded fiberglass reinforced resin or a sheet molding compound. The lower hull section 36 and the upper hull section 38 are coupled together to define an internal cavity which wholly or partially defines an engine compartment 40. The hull 36 houses an internal combustion engine 44 in the engine compartment 40. An intersection of the hull sections 36, 38 is defined in part along an outer surface gunwale or bulwark 42.

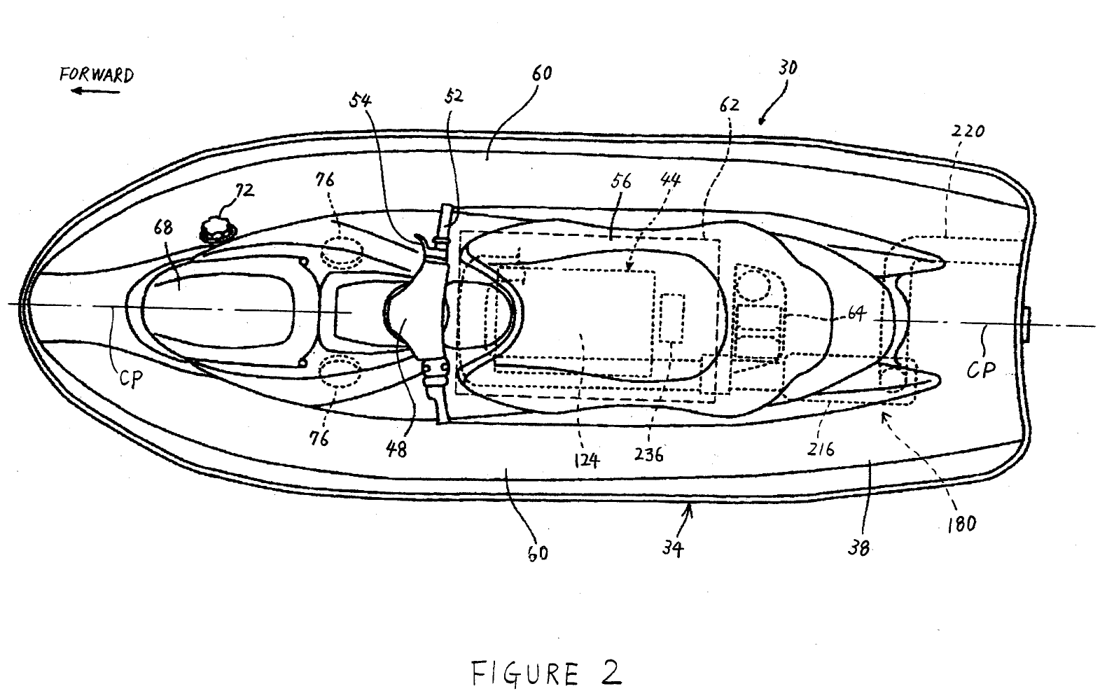

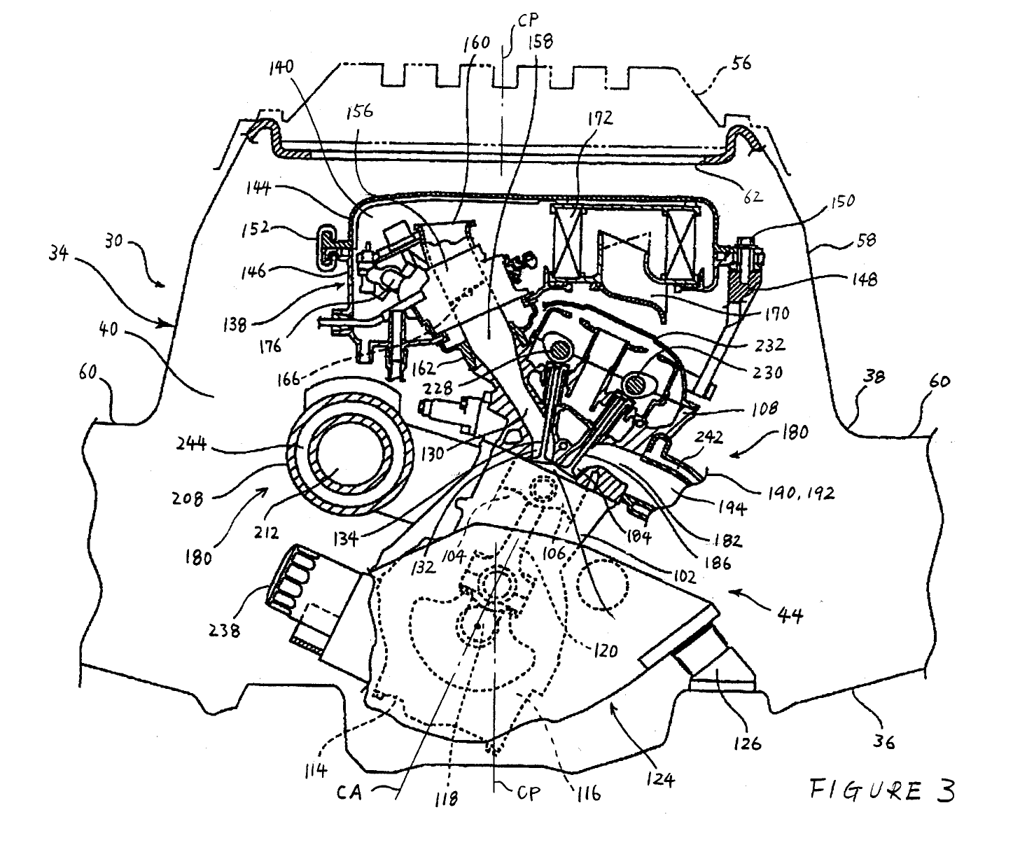

As shown in FIGS. 2 and 3, the hull 34 defines a center plane CP that extends generally vertically from bow to stem with the watercraft 30 floating in a normal upright position. The lower hull section 36 is designed such that the watercraft 30 planes or rides on a minimum surface area at the aft end of the lower hull 38 in order to optimize the speed and handling of the watercraft 30 when up on plane. For this purpose, the lower hull section 36 generally has a V-shaped configuration formed by a pair of inclined sections that extend outwardly from the center plane CP of the hull 34 to the hull's side walls at a dead rise angle.

Each inclined section desirably includes at least one strake. The strakes preferably are symmetrically disposed relative to the keel line of the watercraft 30. The inclined sections also extend longitudinally from the bow toward the transom of the lower hull 38 along the center plane CP. The side walls are generally flat and straight near the stem of the lower hull 38 and smoothly blend toward the center plane CP at the bow. The lines of intersection between the inclined sections and the corresponding side walls form the outer chines of the lower hull section 36.

A steering mast 48 extends generally upwardly from a bow area 50 toward the top of the upper hull section 38 to support a handlebar 52. The handlebar 52 is provided primarily for a rider to control the steering mast 48 so that a thrust direction of the watercraft 50 is properly changed. The handlebar 52 also carries control devices such as, for example, an engine output request device, such as a throttle lever 54 (FIG. 2) for operating throttle valves of the engine 44.

A seat 56 extends fore to aft along the center plane CP at a location behind the steering mast 48. The seat 56 has generally a saddle shape so that the rider can straddle the seat 56. The illustrated upper hull section 38 defines a seat pedestal 58 and the seat 56 is detachably or hingedly affixed to the seat pedestal 58. Foot areas 60 (FIG. 2) are defined on both sides of the seat 56 and at the top surface of the upper hull section 38.

An access opening 62 (FIGS. 2 and 3) is defined on the top surface of the seat pedestal 58 under the seat 56. The rider thus can access the engine compartment 59 through the access opening 62. The upper hull section 38 also defines a storage box 64 under the seat 56 in the rear of the access opening 62 within the seat pedestal 58.

The upper hull section 38 defines a storage recess in the bow area 50 and in front of the steering mast 48. A hatch 68 is hinged or detachably affixed to the upper hull section 38 to close the storage recess.

A fuel tank 70 is placed in the internal cavity under the upper hull section 38 and preferably in front of the engine 44. The fuel tank 70 is coupled with a fuel inlet port positioned at a top surface of the upper hull section 38 through a filler duct. A closure cap 72 (FIG. 2) closes the fuel inlet port.

Air ducts or ventilation ducts 76 are provided at appropriate locations of the upper hull section 38 so that the ambient air can enter the internal cavity 40 through the ducts 76, and to allow air within the cavity 40 to flow to the atmosphere. Except for the air ducts 76, the engine compartment 40 is substantially sealed so as to protect the engine 44 and engine related components from water.

A jet pump assembly 80 propels the watercraft 30. The jet pump assembly 80 is mounted in a tunnel or pump housing 82 formed on the underside of the lower hull section 58. Optionally, the tunnel 82 can be isolated from the engine compartment 44 by a bulkhead. The tunnel 82 has a downward facing inlet port 84 opening toward the body of water.

The jet pump assembly 80 includes an impeller (not shown) that is journaled in a jet water passage defined within the pump assembly 80. An impeller shaft 88 extends forwardly from the impeller and is coupled with an output shaft 90 that extends from the engine 44 by a coupling unit 92 to be driven by the output shaft 90.

The rear end of the pump assembly 80 defines a discharge nozzle 96. A deflector or steering nozzle 98 is affixed to the discharge nozzle 96 for pivotal movement about a steering axis which extends generally vertically. A cable connects the deflector 98 with the steering mast 48 so that the rider can steer the deflector 98.

When the output shaft 90 of the engine 44 drives the impeller shaft and the impeller thus rotates, water is drawn from the surrounding body of water through the inlet opening 84. The pressure generated in the pump assembly 80 by the impeller produces a jet of water that is discharged through the discharge nozzle 96 and the deflector 98. The water jet thus produces thrust to propel the watercraft 30.

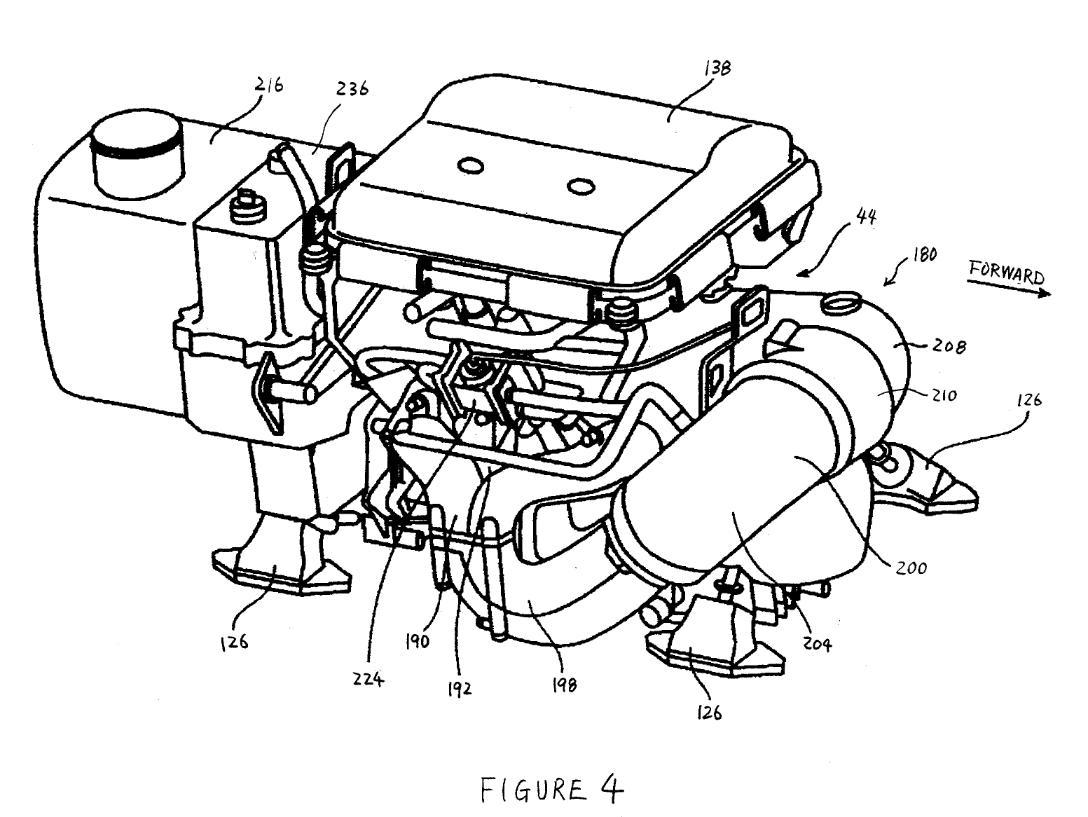

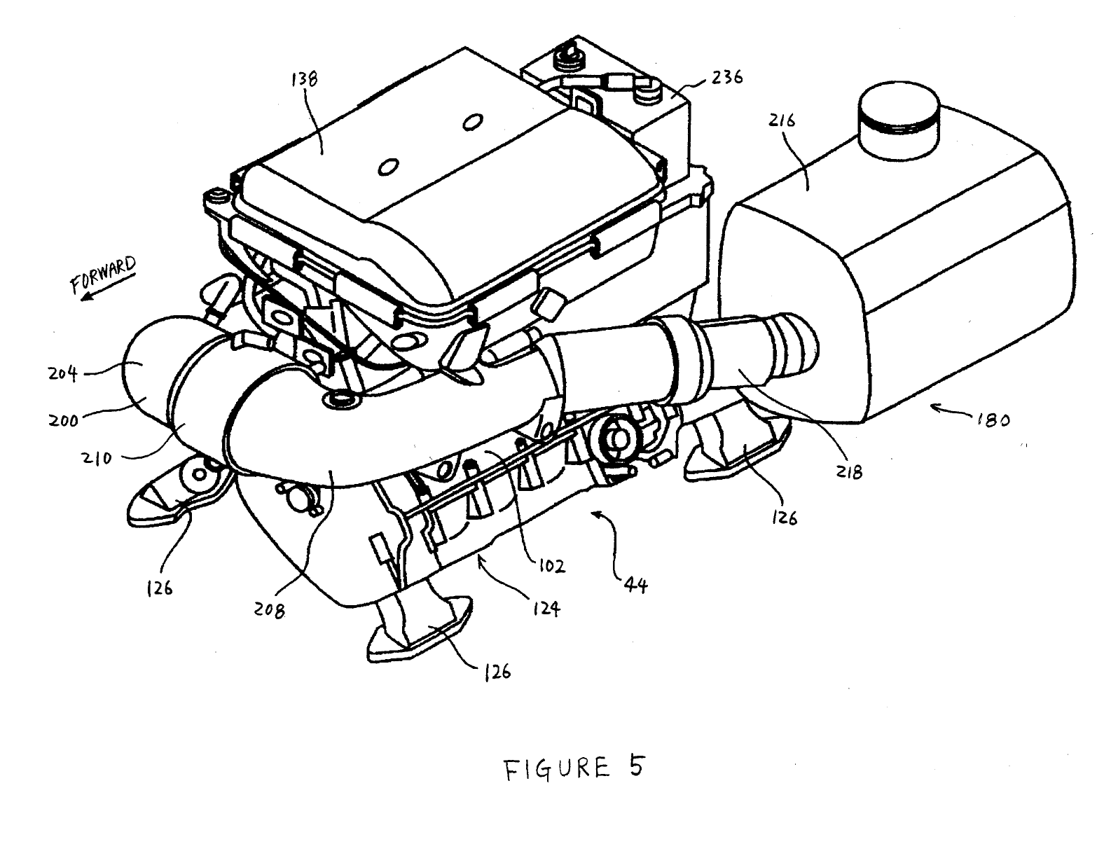

With continued reference to FIG. 3 and additional reference to FIGS. 4-6, the engine 44 operates on a four-cycle combustion principle. The engine 44 comprises a cylinder block 102 that preferably defines four inclined cylinder bores 104 arranged from fore to aft along the center plane CP. The engine 44 thus is a L4 (in-line four cylinder) type engine. The illustrated four-cycle engine, however, merely exemplifies one type of engine. Engines having other number of cylinders including a single cylinder, and having other cylinder arrangements (e.g., V and W type) and other cylinder orientations (e.g., upright cylinder banks) are all practicable.

Each cylinder bore 104 has a center axis CA that is slanted with a certain angle from the center plane CP so that the overall height of the engine 44 is shorter. All the center axes CA of the cylinder bores 104 preferably have the same angle relative to the center plane CP.

Moveable members such as pistons 106 move relative to the cylinder block 102 and specifically within the cylinder bores 104. A cylinder head member 108 is affixed to an upper end portion of the cylinder block 102 to close respective upper ends of the cylinder bores 104 to define combustion chambers 110 with the cylinder bores 104 and the pistons 106.

A crankcase member 114 is affixed to a lower end portion of the cylinder block 102 to close respective lower ends of the cylinder bores 104 and to define a crankcase chamber 116 with the cylinder block 102. A crankshaft 118 is journaled for rotation by at least one bearing formed on the crankcase member 114. Connecting rods 120 couple the crankshaft 118 with the pistons 106 so that the crankshaft 118 rotates with the reciprocal movement of the pistons 106. The foregoing output shaft 90 is coupled with the crankshaft 118 through an appropriate transmission mechanism. Optionally, the transmission mechanism can include at least one gear reduction set, allowing the engine to operate at speeds higher than the speed of the impeller.

The cylinder block 102, the cylinder head member 108 and the crankcase member 114 together define an engine body 124. The engine body 124 preferably is made of aluminum based alloy. In the illustrated embodiment, the engine body 124 is oriented in the engine compartment 40 to position the crankshaft 118 generally parallel to the center plane CP and to extend generally in the longitudinal direction. Other orientations of the engine body 124, of course, also are possible (e.g., with a transverse or vertically-oriented crankshaft).

Engine mounts 126 extend from both sides of the engine body 124. The engine mounts 126 preferably include resilient portions made of flexible material, for example, a rubber material. The engine body 124 is mounted on the lower hull section 36, specifically, a hull liner, by the engine mounts 126 so as to inhibit vibrations of the engine 44 from being transferred to the hull section 36.

The engine 44 preferably comprises an air intake system configured to guide air to the engine body 124, and thus to the combustion chambers 110. The illustrated air intake system includes four inner intake passages 130 defined in the cylinder head member 108, at least a portion of each extending generally horizontally. The inner intake passages 130 communicate with the associated combustion chambers 110 through one or more intake ports 132. Intake valves 134 are provided at the intake ports 132 to selectively connect and disconnect the intake passages 130 with the combustion chambers 110.

Preferably, the air intake system also includes a plenum chamber assembly or air intake box 138 for smoothing and quieting intake air. The illustrated plenum chamber assembly 138 is made of plastic. The illustrated plenum chamber assembly 138 has a generally rectangular shape in top and bottom plan views and defines a plenum chamber 140 therein. Other shapes of the plenum chamber assembly 138 of course are possible, but it is preferable to make the plenum chamber 140 as large as possible within the space provided between the engine body 124 and the seat 56.

With reference to FIG. 3, the plenum chamber assembly 138 comprises an upper chamber member 144 and a lower chamber member 146. The lower chamber member 146 preferably is coupled with the engine body 124. In the illustrated embodiment, several stays 148 extend upwardly from the engine body 124 and several bolts 150 rigidly affix the lower chamber member 146 to respective top surfaces of the stays 148. Several coupling or fastening members 152, which are generally configured as a shape of the letter “C” in section, couple the upper chamber member 144 with the lower chamber member 146.

The lower chamber member 146 defines four apertures aligned parallel to the center plane CP. Preferably, four throttle bodies 156 extend through the apertures and are affixed to the lower chamber member 146 with a seal member. The throttle bodies 156 are generally positioned on the port side of the plenum chamber 140.

Respective bottom ends of the throttle bodies 156 are coupled with the associated inner intake passages 130. The throttle bodies 156 preferably extend generally vertically but slant toward the port side oppositely from the center axis CA of the engine body 124. The throttle bodies 156 define outer intake passages 158 with air inlets 160 opening upwardly within the plenum chamber 140. Each throttle body 156 includes a rubber boot 162 which extends between the lower chamber member 146 and the cylinder head member 108 and defines a portion of the outer intake passage 158 therein so that the outer intake passages 158 are connected to the inner intake passages 130.

Air in the plenum chamber 140 is drawn into the combustion chambers 110 through the outer and inner intake passages 158, 130 when negative pressure is generated in the combustion chambers 110. The negative pressure is generally made when the pistons 106 move toward the bottom dead center from the top dead center.

A throttle valve 166 is separately provided in each throttle body 156 and is journaled for pivotal movement. A valve shaft links all of the throttle valves 166 to synchronize the valves 166 with each other. The pivotal movement of the valve shaft is controlled by the throttle lever 54 on the handle bar 52 through a control cable that is connected to the valve shaft. The rider thus can control an opening degree of each throttle valve 166 by operating the throttle lever 54 to obtain various engine speeds. That is, the throttle valves 166 pivot between a fully closed position and a fully open position to meter or regulate an amount of air passing through the throttle bodies 156. Normally, the greater the opening degree of the throttle valves 166, the higher the rate of airflow and the higher the load on the engine and thus the higher the engine speed.

With continued reference to FIG. 3, air in the engine compartment 40 is drawn into the plenum chamber 140 through four air inlet ports 170. The air inlet ports 170 align with each other fore to aft along the center plane CP and on the starboard side opposite to the throttle bodies 156. A filter or air cleaner unit 172 preferably surrounds the inlet ports 170. The filter unit 172 contains at least one filter element therein. All of the air that comes into the inlet ports 170 inevitably goes through the filter element, which removes foreign substances, including water, from the air.

The engine 44 preferably comprises an indirect or port fuel injection system. The fuel injection system includes four fuel injectors 176 with one injector allotted to each throttle body 156. The fuel injectors 176 are affixed to a fuel rail (not shown) that is mounted on the throttle bodies 156. The fuel injectors 176 have injection nozzles that open downstream of the throttle valves 166. More specifically, the injection nozzles preferably are opened and closed by an electromagnetic component, such as a solenoid unit, which is slideable within an injector body. The solenoid unit generally comprises a solenoid coil, which is controlled by signals from an ECU (electronic control unit). Although not shown, the ECU preferably is mounted on the engine body 124 or on a member that defines the engine compartment 40 together with other members.

When each nozzle is opened, pressurized fuel is released from the fuel injectors 176. The fuel injectors 176 thus spray the fuel into the outer intake passages 158 during an open timing of the intake ports 132. The sprayed fuel enters the combustion chambers 110 with the air that passes through the outer and inner intake passages 158, 130.

The fuel is supplied to the fuel injectors 176 from the fuel tank 70. In the illustrated arrangement, the fuel is pressurized by fuel pumps. A pressure regulator preferably regulates the pressure. The fuel injection system can incorporate various devices and components such as, for example, a vapor separator other than the fuel pumps and the pressure regulator.

The fuel injectors 176 spray fuel at an injection timing and duration under control of the ECU. That is, the solenoid coil is supplied with electric power at the selected timing and for the selected duration. Because the pressure regulator controls the fuel pressure, the duration can be used to control the amount of fuel that will be injected.

The sprayed fuel is drawn into the combustion chambers 110 together with the air to form an air-fuel charge therein. Holding a proper air-fuel ratio is one of the most significant matters in control of the engine operations. Basically, the ECU controls an amount of the fuel (more specifically, the duration) to keep the air-fuel ratio at the stoichiometric air-fuel ratio under normal running conditions. Optionally, the ECU can be configured to achieve “lean-burn” or “ultra-lean burn” operation in accordance with other known fuel control scenarios.

The engine 44 preferably comprises a firing or ignition system. The firing system includes four spark plugs, one spark plug allotted to each combustion chamber 110. The spark plugs are affixed to the cylinder head member 108 so that electrodes, which are defined at ends of the plugs, are exposed to the respective combustion chambers 110. The spark plugs fire the air-fuel charges in the combustion chambers 110 at each ignition timing under control of the ECU. The air-fuel charges thus are burned within the combustion chambers 110 to move the pistons 106 generally downwardly.

With reference to FIGS. 1-8, the engine 44 preferably is provided with an exhaust system 180 to guide burnt charges, i.e., exhaust gases, from the combustion chambers 110 to an external location. In the illustrated embodiment, the exhaust system 180 includes four inner exhaust passages 182 defined within the cylinder head member 108. The inner exhaust passages 182 communicate with the associated combustion chambers 110 through one or more exhaust inner ports 184. Exhaust valves 186 are provided at the exhaust ports 184 to selectively connect and disconnect the exhaust passages 182 from the combustion chambers 110.

With particular reference to FIGS. 4 and 6-8, first and second exhaust manifolds 190, 192 depend from the cylinder head member 108 at a side surface thereof on the starboard side. The exhaust manifolds 190, 192 each define two outer exhaust passages 194 that are coupled with the inner exhaust passages 182 to collect exhaust gases from the respective inner exhaust passages 182.

The first exhaust manifold 190 has a pair of upstream end portions spaced apart from each other with a length that is equal to a distance between the forward-most exhaust passage 182 and the rearward-most exhaust passage 182. The upstream end portions are connected with the forward-most and rearward-most exhaust passages 182.

The second exhaust manifold 192 also has a pair of upstream end portions spaced apart from each other with a length that is equal to a distance between the other two or in-between exhaust passage 182. The upstream end portions are connected with the exhaust passages 182 between the outer-most passages. The first exhaust manifold 190 defines individual exhaust passages 190a therein and the second exhaust manifold 192 defines individual exhaust passages 192a therein.

The first and second exhaust manifolds 190, 192 extend slightly downwardly. Respective downstream ends of the first and second exhaust manifolds 190, 192 are connected to an upstream end of a first unitary exhaust conduit 198.

The first unitary conduit 198 extends further downwardly and then upwardly and forwardly in the downstream direction. The first unitary conduit 198 defines individual exhaust passages 198a therein, two of which are coupled with the individual exhaust passages 190a of the first exhaust manifold 190 while other two of which are coupled with the individual exhaust passages 192a of the second exhaust manifold 192.

A downstream end of the first unitary conduit 198 is connected to an upstream end of a second unitary exhaust conduit 200. The illustrated second unitary exhaust conduit 200 forms a twofold conduit construction that comprises an inner conduit section 202 and an outer conduit section 204. The inner conduit section 202 defines individual exhaust passages 202a which are coupled with the individual exhaust passages 198a of the first unitary conduit.

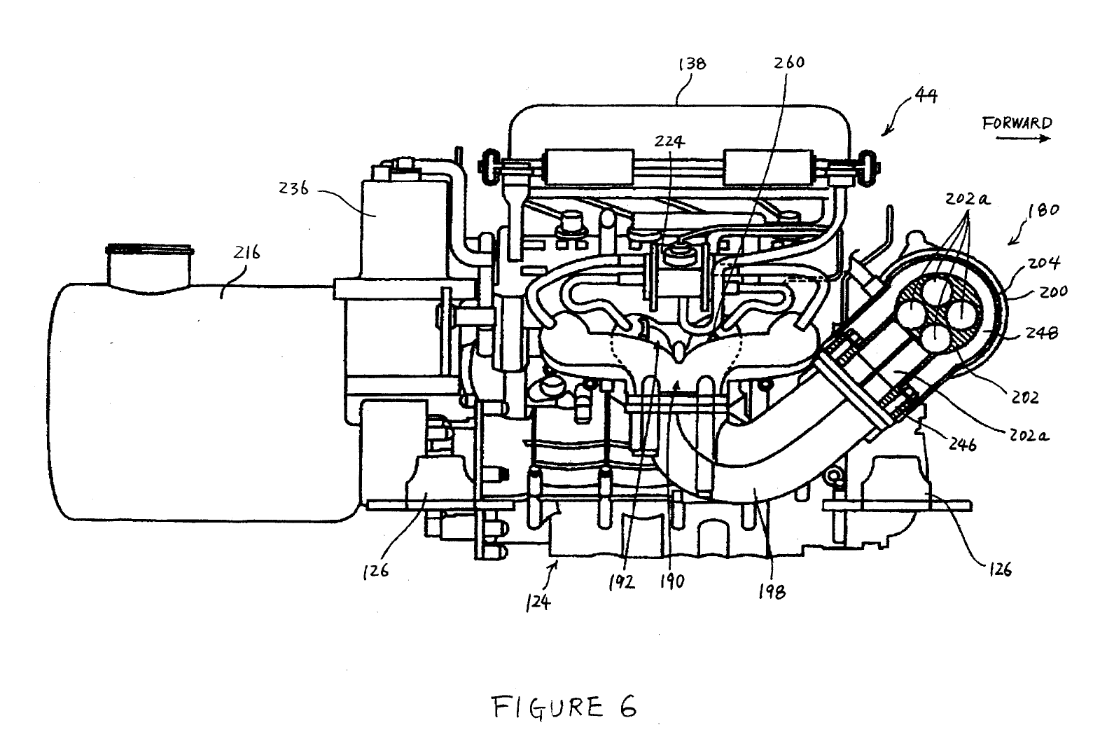

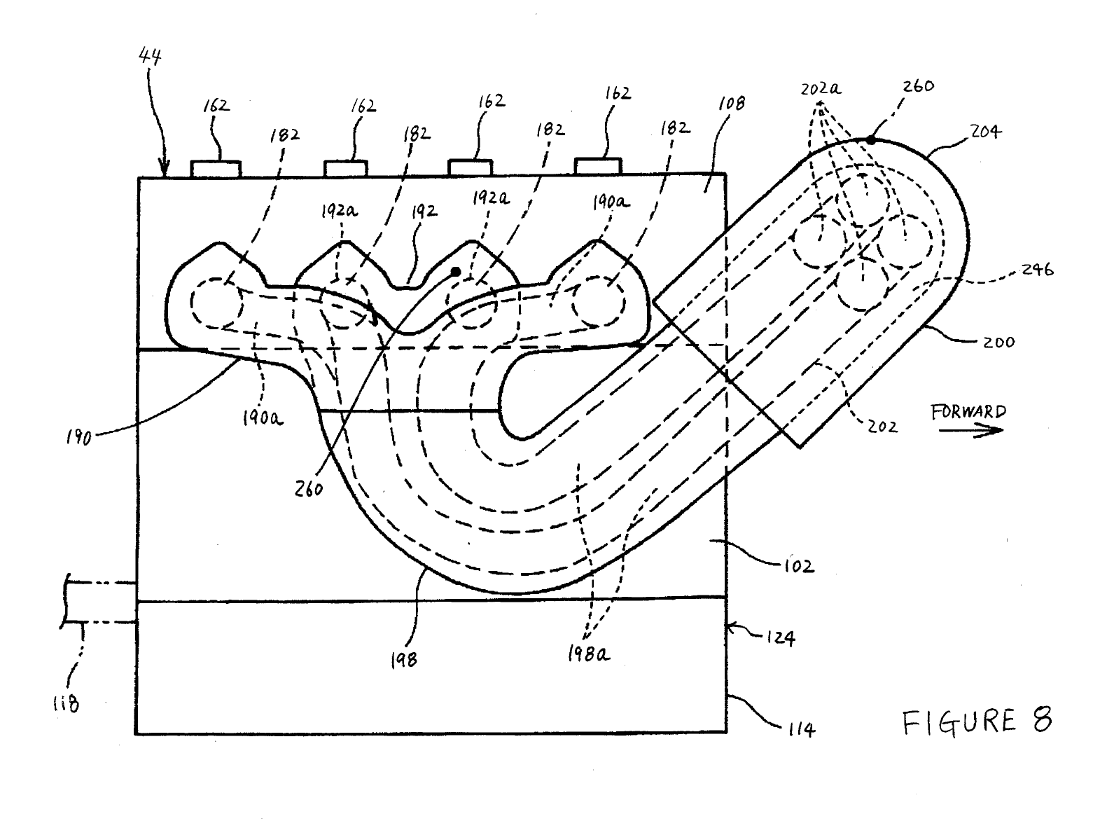

In the illustrated arrangement, with particular reference to FIGS. 6 and 8, one of the exhaust passages 202a is positioned higher than other three exhaust passages 202a. Two of those three exhaust passages 202a are disposed at the same level but lower than the first one of the exhaust passages 202a. The remaining one of the exhaust passages 202a is placed at the lower-most position.

The outer conduit section 204 is made of rubber material and surrounds the inner conduit 202. The outer conduit section 204 is spaced apart from the inner conduit section 202.

The second unitary conduit 200 extends further upwardly then transversely, relative to the center plane CP of the hull 34, and terminates in front of the engine body 124. The second unitary conduit 200 is connected to an exhaust pipe 208 on the front side of the engine body 124. This coupled portion is positioned at the highest location in the exhaust system 180 and preferably is supported by a front surface of the engine body 124 via a support member 210. The exhaust pipe 208 defines a single exhaust passage 212 and all of the individual exhaust passages 202a merge together into the single exhaust passage 212.

The exhaust pipe 208 extends rearwardly along a side surface of the engine body 124 on the port side and then is connected to an exhaust silencer or water-lock 216 at a forward surface of the exhaust silencer 216 via a rubber hose 218. With particular reference to FIG. 2, the exhaust silencer 216 preferably is placed at a location generally behind and on the port side of the engine body 124. The exhaust silencer 216 is secured to the lower hull 36 or to the hull liner.

A discharge pipe 220 extends from a top surface of the exhaust silencer 216 and transversely across the center plane CP to the starboard side. The discharge pipe 220 then extends rearwardly and opens at the stem or the pump housing 82 74 and thus to the exterior of the watercraft 30 in a submerged position. The exhaust silencer 216 has one or more expansion chambers to reduce exhaust noise and also to inhibit water in the discharge pipe 220 from entering the exhaust pipe 208 even if the watercraft 30 capsizes.

With reference to FIGS. 4 and 6, the engine 44 preferably comprises an air injection system (AIS) that includes a secondary air injection device 224 connected to the intake and exhaust systems. The AIS supplies a portion of the air passing through the air intake system to the exhaust system 180 to clean the exhaust gases therein. For example, hydro carbon (HC) and carbon monoxide (CO) components of the exhaust gases can be removed by an oxidation reaction with oxygen (02) that is supplied to the exhaust system 180 through the AIS.

With reference back to FIG. 3, the engine 44 has a valve actuation mechanism for actuating the intake and exhaust valves 134, 186. In the illustrated embodiment, the valve actuation mechanism comprises a double overhead camshaft drive including an intake camshaft 228 and an exhaust camshaft 230. The intake and exhaust camshafts 228, 230 actuate the intake and exhaust valves 134, 186, respectively. The intake camshaft 228 extends generally horizontally over the intake valves 134 from fore to aft parallel to the center plane CP, while the exhaust camshaft 230 extends generally horizontally over the exhaust valves 186 from fore to aft also parallel to the center plane CP. Both the intake and exhaust camshafts 228, 230 are journaled for rotation by the cylinder head member 108 with a plurality of camshaft caps, which are affixed to the cylinder head member 108. A cylinder head cover member 232 extends over the camshafts 228, 230 and the camshaft caps, and is affixed to the cylinder head member 108 to define a camshaft chamber. The foregoing stays 148 and the secondary air injection device 224 preferably are affixed to the cylinder head cover member 232.

The intake and exhaust camshafts 228, 230 have cam lobes associated with the intake and exhaust valves 134, 186, respectively. The intake and exhaust valves 134, 186 normally close the intake and exhaust ports 132, 184 by biasing force of springs. When the intake and exhaust camshafts 228, 230 rotate, the respective cam lobes push the associated valves 134, 186 to open the respective ports 132, 184 against the biasing force of the springs. The air thus can enter the combustion chambers 110 at every opening timing of the intake valves 134 and the exhaust gases can move out from the combustion chambers 110 at every opening timing of the exhaust valves 186.

The crankshaft 118 preferably drives the intake and exhaust camshafts 228, 230. Preferably, the respective camshafts 228, 230 have driven sprockets affixed to ends thereof. The crankshaft 118 also has a drive sprocket. Each driven sprocket has a diameter which is twice as large as a diameter of the drive sprocket. A timing chain or belt is wound around the drive and driven sprockets. When the crankshaft 118 rotates, the drive sprocket drives the driven sprockets via the timing chain, and then the intake and exhaust camshafts 228, 230 rotate also. The rotational speed of the camshafts 228, 230 are reduced to half of the rotational speed of the crankshaft 118 because of the differences in diameters of the drive and driven sprockets.

In operation, ambient air enters the engine compartment 40 defined in the hull 34 through the air ducts 76. The air is introduced into the plenum chamber 140 defined by the plenum chamber assembly 138 through the air inlet ports 170 and then is drawn into the throttle bodies 156. The air cleaner element of the filter unit 172 cleans the air. The majority of the air except for the air to the AIS in the plenum chamber 140 is supplied to the combustion chambers 110.

The throttle valves 166 in the throttle bodies 156 regulate an amount of the air flowing toward the combustion chambers 110. The opening amounts of the throttle valves 166, which are directly-controlled by the rider with the throttle lever 54 in the illustrated embodiment, regulates the airflow across the valves. The air flows into the combustion chambers 110 when the intake valves 134 are opened. At the same time, the fuel injectors 176 spray fuel into the outer intake passages 158 under the control of the ECU. Air-fuel charges thus are formed and are delivered to the combustion chambers 110.

The air-fuel charges are fired by the spark plugs also under the control of the ECU. The burnt charges, i.e., exhaust gases, are discharged to the body of water surrounding the watercraft 30 through the exhaust system 180. A relatively small amount of the air in the plenum chamber 140 is supplied to the exhaust system 180 through the AIS to purify the exhaust gases. The burning of the air-fuel charge makes the pistons 106 reciprocate within the cylinder bores 104 to rotate the crankshaft 118.

The engine 44 preferably includes a lubrication system that delivers lubricant oil to engine portions for inhibiting frictional wear of such portions. In the illustrated embodiment, a closed-loop type, dry-sump lubrication system is employed. Lubricant oil for the lubrication system preferably is stored in a lubricant reservoir or tank 236 (FIGS. 2 and 4-6) disposed in the rear of the engine body 124 and is affixed thereto. An oil filter unit 238 (FIG. 3) is detachably mounted on the crankcase member 114 on the port side. The oil filter unit 238 contains at least one filter element to remove alien substances from the lubricant oil circulating in the lubrication system. The oil filter unit 238 also can separate water component from the lubricant oil. The lubrication system includes one or more oil pumps that preferably are driven by the crankshaft 118 in the circulation loop to deliver the oil in the lubricant reservoir 236 to the engine portions that need lubrication and to return the oil to the reservoir 236.

The watercraft 30 preferably employs a water cooling system for the engine 44 and the exhaust system 180. Preferably, the cooling system is an open-loop type and includes a water pump and a plurality of water jackets and/or conduits. In the illustrated arrangement, the jet pump assembly 80 is used as the water pump with a portion of the water pressurized by the impeller being drawn off for the cooling system, as known in the art.

The engine body 124, the first and second exhaust manifolds 190, 192, the first and second unitary conduits 198, 200 and the exhaust pipe 208 define the water jackets. Both portions of the water to the water jackets of the engine body 124 and to the water jackets of the exhaust system 180 can flow through either common channels or separate channels formed within one or more exhaust components 190, 192, 198, 200, 208 or external water pipes. The illustrated exhaust components 190, 92, 198, 200, 208 preferably are formed as dual passage structures in general.

More specifically, with reference to FIG. 3, in connection with the exhaust manifolds 190, 192 and the exhaust pipe 208, water jackets 242, 244 are defined around the exhaust passages 194, 212 thereof, respectively. With reference to FIGS. 6 and 8, the first unitary conduit 198 has a water jacket 246 that is unitarily formed with the individual exhaust passages 198a. The water jacket 246 is coupled to the water jackets 242 of the exhaust manifolds 190, 192.

The second unitary conduit 200 also defines a water jacket 248 between the outer surface of the inner conduit section 202 and the inner surface of the outer conduit section 204. The water jacket 248 is coupled to the water jacket 246 of the first unitary conduit 198. The downstream end of the illustrated water jacket 248 opens to the single exhaust passage 212. Thus the water in the water jacket 248 is discharged to the exhaust passage 212 and then flows down to the discharge pipe 220 and is finally discharged to the external location with the exhaust gases.

The engine 44 and the exhaust system 180 are disclosed in, for example, U.S. Pat. No. 6,454,622 titled EXHAUST SYSTEM FOR 4-CYCLE ENGINE OF SMALL WATERCRAFT, the entire contents of which is hereby expressly incorporated by reference.

The ECU can use various information for controlling the fuel injectors 176, spark plugs and other engine actuators. Such information includes data indicative of conditions of the engine operation. As described above, the ECU can be configured to actively maintain a proper air-fuel ratio. For example, the ECU can define at least a part of a feedback control system which detects conditions indicative of the air-fuel ration of a fuel air charge and adjusts the operation of the fuel delivery system to achieve a desired air-fuel ratio. In one mode, the ECU can use data indicative of the residual amount of oxygen in the exhaust gases to determine the air-fuel ratio of the corresponding air-fuel charge.

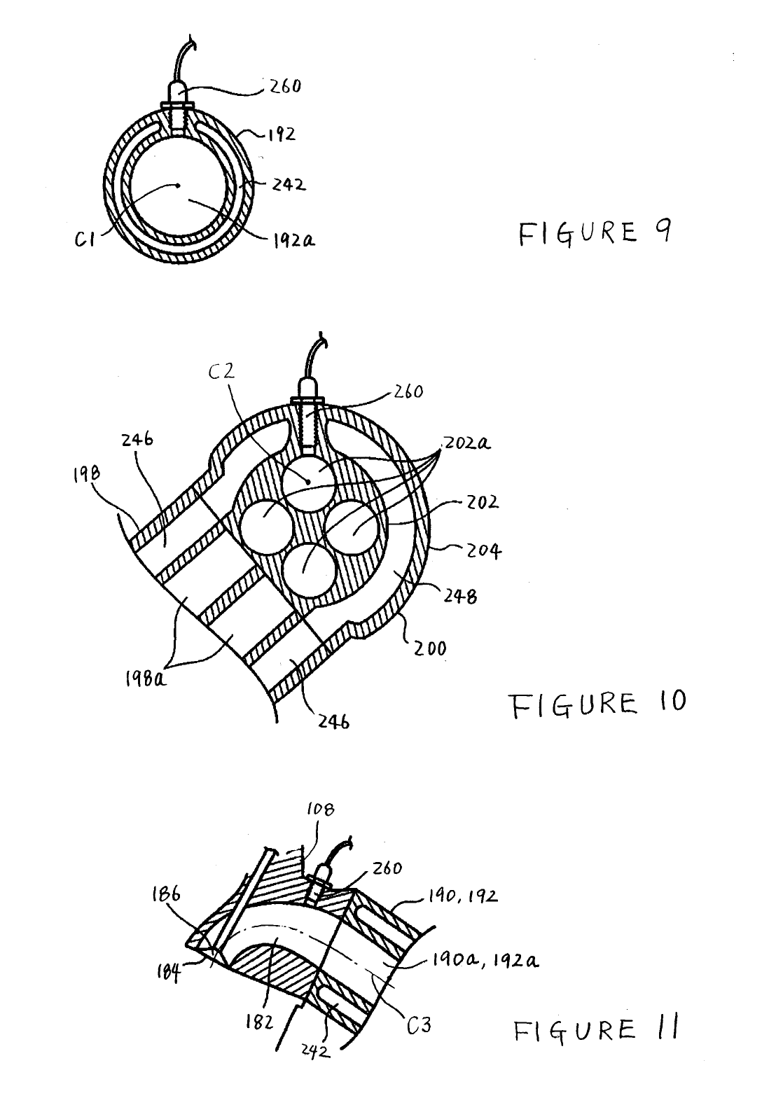

With continued reference to FIGS. 6-8 and with additional reference to FIG. 9, the illustrated exhaust system 180 includes an oxygen (O₂) sensor 260 to detect such a residual amount of oxygen. Advantageously, the oxygen sensor 260 is disposed in an upper portion of one of the individual exhaust passages defined by the exhaust system 180. Thus, the sensor 260 is better protected from water than may be present in the exhaust system.

In the illustrated embodiment, the oxygen sensor 260 is connected to the exhaust manifold 192 and is exposed to the exhaust passage 192a. Preferably, the oxygen sensor 260 is positioned generally higher than a center C1 (FIG. 9) of the associated exhaust passage 192a. Additionally, the oxygen sensor 260 is disposed in a generally horizontally extending portion of the passage 192a. Of course, the oxygen sensor 260 can be located at the other exhaust manifold 190.

Because the exhaust manifolds 190, 192 are located at the furthest-upstream positions in the exhaust system 180, it is less likely that water, which may be present in the exhaust passages, can reach the oxygen sensor 260. Moreover, the oxygen sensor 260 is positioned higher than the center C1 of the associated exhaust passage 192a. The sensor 260 thus is further protected from such water.

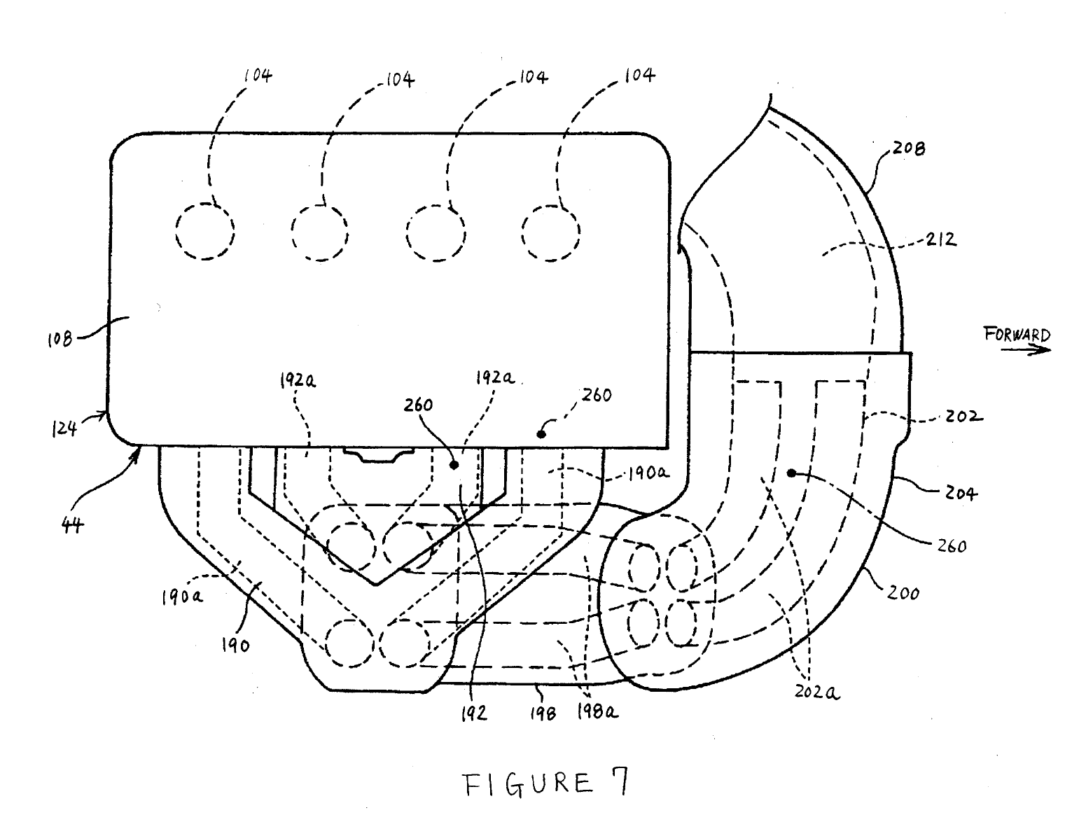

With reference to FIGS. 7, 8 and 10, in accordance with another embodiment of at least one invention disclosed herein, the oxygen sensor 260 can be placed at the second unitary conduit 200 and exposed to one of the exhaust passages 202a that is positioned higher than other three exhaust passages 202a. Preferably, the oxygen sensor 260 is positioned higher than a center C2 (FIG. 10) of the associated exhaust passage 202a. Alternatively, the oxygen sensor 260 can be exposed to either one of exhaust passages 202a which are disposed at the medium level. The oxygen sensor 260 can be exposed even to the exhaust passage 202a which is placed positioned at most-lowered position. However, the higher the level, the better the effect inhibiting the water from approaching. Because the second unitary conduit 200 is located at a high point in the exhaust system 180, any water therein is less likely to ascend to the exhaust passage 202a. The oxygen sensor 260 is further protected because the conduit 200 extends generally horizontally at the location of the oxygen sensor 260. Thus, the influence of gravity further aids in preventing water from contacting the sensor 260.

In this embodiment, the configuration of the exhaust system 180 provides additional protection to the oxygen sensor 260. For example, because the exhaust system 180 includes individual passages down stream from the exhaust manifolds 190,192, water flowing upstream through the exhaust system from the unitary conduit 208 will be divided as it reaches the passages 202a defined in the conduit 202. Under the influence of gravity, such an upstream flow of water will most likely be diverted in to the lower-most of the passages 202a. Thus, by locating the oxygen sensor 260 in the upper-most of the passages 202a, the upstream flow of water will likely be separated from the sensor 260.

With reference to FIGS. 7 and 11, in accordance with yet another embodiment of at least one of the inventions disclosed herein, the oxygen sensor 260 can be placed at the cylinder head member 108, being exposed to one of the inner exhaust passages 182. Preferably, the oxygen sensor 260 is positioned higher than a center C3 (FIG. 11) of the associated inner exhaust passage 182. In the illustrated arrangement, the oxygen sensor 260 is positioned at one of the inner exhaust passages 182 that communicates with one of the exhaust passages 190a of the exhaust manifold 190. Additionally, the oxygen sensor 260 is disposed in a generally horizontally extending portion of the passage 182. However, the oxygen sensor 260 can, of course, be positioned at any of the inner exhaust passages 182.

Because the inner exhaust passage 182 is positioned at the most upstream portion of the exhaust system 180, no water has chance to reach the oxygen sensor 260.

Various modified arrangements of the oxygen sensor are applicable inasmuch as that the oxygen sensor is positioned either at one of the inner exhaust passages or the individual exhaust passages. Because such exhaust passages are farther from the water than any other portions of the exhaust system, the water is well inhibited from approaching the oxygen sensor.

Sensors other than the oxygen sensor can be provided in the exhaust system to detect conditions of the exhaust gases. For instance, an exhaust temperature sensor can be placed at any one of the positions described above. The exhaust temperature sensor normally is coupled with a catalyzer and thus the catalyzer preferably is placed at the same location as the exhaust temperature sensor is placed.

Of course, the foregoing description is that of preferred arrangements having certain features, aspects and advantages in accordance with the present invention. Various changes and modifications may be made to the above-described arrangements without departing from the spirit and scope of the invention, as defined by the appended claims.

What is claimed is:

1. A watercraft comprising an internal combustion engine, an exhaust system arranged to guide exhaust gases from the engine to an external location, and at least one sensor configured to detect a condition of the exhaust gases, the engine comprising an engine body, a plurality of movable members movable within the engine body, the engine body and the movable members together defining a plurality of combustion chambers, the engine body additionally defining a plurality of inner exhaust passages that communicate with the respective combustion chambers, the exhaust system comprising an exhaust conduit defining individual exhaust passages that communicate with the respective inner exhaust passages, the sensor being positioned either at an upper portion of the inner exhaust passages or the individual exhaust passages.

2. The watercraft as set forth in claim 1, wherein a body of the sensor is placed generally higher than a center of the inner exhaust passage or a center of the individual exhaust passage.

3. The watercraft as set forth in claim 1, wherein the individual exhaust passages extend from a side of the engine body to a longitudinal end of the engine body, and wherein the sensor comprises an oxygen sensor disposed at a downstream end of one of the individual exhaust passages.

4. The watercraft as set forth in claim 1, wherein the exhaust conduit is formed with a plurality of conduit sections, the individual exhaust passages are defined in one of the conduit sections that is directly coupled with the respective inner exhaust passages.

5. The watercraft as set forth in claim 1, wherein one of the individual exhaust passages is positioned higher than another one of the individual exhaust passages, the sensor is positioned at the one of the individual exhaust passages.

6. The watercraft as set forth in claim 5, wherein the exhaust conduits defines at least three individual exhaust passages, the sensor is positioned at one of the individual exhaust passages that is not placed at the most-lowered position.

7. The watercraft as set forth in claim 1, wherein the exhaust system additionally comprising a second exhaust conduit disposed downstream of the first exhaust conduit, the second exhaust conduit defining a single exhaust passage that communicates with the respective individual exhaust passages.

8. A watercraft comprising a multiple cylinder engine defining a plurality of combustion chambers, an exhaust system arranged to guide exhaust gases from the combustion chambers to an external location, the exhaust system defining a plurality of parallel exhaust passages that communicate with the respective combustion chambers, and an oxygen sensor positioned at an upper portion of one of the exhaust passages.

9. The watercraft as set forth in claim 8, wherein a body of the oxygen sensor is placed generally higher than a center of the one of the exhaust passages.

10. An internal combustion engine for a watercraft comprising an engine body, a plurality of movable members movable within the engine body, the engine body and the movable members together defining a plurality of combustion chambers, the engine additionally defining a plurality of inner exhaust passages that include a generally horizontally extending portion and that communicate with the respective combustion chambers, an exhaust system arranged to guide exhaust gases from the combustion chambers to an external location, the exhaust system comprising an exhaust conduit defining individual exhaust passages that include at least one generally horizontally extending portion and that communicate with the respective inner exhaust passages, and a sensor configured to detect a condition of the exhaust gases, the sensor being positioned at an upper portion of a generally horizontally extending portion of either one of the inner exhaust passages or the individual exhaust passages.

11. The engine as set forth in claim 10, wherein the exhaust conduit is formed with a plurality of conduit sections, the individual exhaust passages are defined in one of the conduit sections that is directly coupled with the respective inner exhaust passages.

12. The engine as set forth in claim 10, wherein one of the individual exhaust passages is positioned higher than another one of the individual exhaust passages, the sensor is positioned at the one of the individual exhaust passages.
